(19) United States
(12) Patent Application Publication
(10) Pub. No.: US 2007/0285011 A1
(43) Pub. Date: Dec. 13, 2007

(54) PLASMA DISPLAY APPARATUS AND DRIVING METHOD THEREOF

(76) Inventor: Jongwoon BAE, Gumi-si (KR)

Correspondence Address: KED & ASSOCIATES, LLP, P.O. Box 221200, Chantilly, VA, 20153-1200, US

(21) Appl. No.: 11/536,929

(22) Filed: Sep. 29, 2006

(30) Foreign Application Priority Data
Jun. 9, 2006 (KR) 10-2006-0052242

(51) Int. Cl. H01J 17/49

(52) U.S. Cl. 313/582

(57) ABSTRACT

A plasma display panel is disclosed. The plasma display panel includes a first electrode, a second electrode, a third electrode, a first barrier rib, and a second barrier rib. The third electrode is formed on a rear substrate to intersect with the first and second electrodes. The first and second barrier ribs which intersect each other form a discharge cell between a front substrate and the rear substrate. The second barrier rib is formed in parallel to the first and second electrodes. One side of each of each of the first electrode and the second electrode is formed to be in alignment with a reference line located at a top portion of the second barrier rib, or is formed to be located at a predetermined distance from the reference line.

This Nonprovisional application claims priority under 35 U.S.C. §119(a) on Patent Application No. 10-2006-0052242 filed in Korea on Jun., 9 2006, filed in Korea on the entire contents of which are hereby incorporated by reference.

### BACKGROUND OF THE INVENTION

1. Field of the Invention

This document relates to a plasma display panel.

2. Description of the Background Art

A plasma display panel comprises a phosphor formed within a discharge cell partitioned by a barrier rib and a plurality of electrodes through which a driving signal is supplied to the discharge cell.

When the driving signal is supplied to the discharge cell, a discharge gas filled in the discharge cell generates vacuum ultraviolet rays. The vacuum ultraviolet rays excite the phosphor formed within the discharge cell such that an image is displayed on the plasma display panel.

### SUMMARY OF THE INVENTION

Accordingly, embodiments of the present invention provide a plasma display panel capable of reducing a reactive power when driving the plasma display panel by reducing capacitance of the plasma display panel.

In one aspect, there is provided a plasma display panel comprising a first electrode and a second electrode formed in parallel to each other on a front substrate, a third electrode formed on a rear substrate to intersect with the first electrode and the second electrode, and a first barrier rib and a second barrier rib which intersect each other for forming a discharge cell between the front substrate and the rear substrate, wherein the second barrier rib is formed in parallel to the first electrode and the second electrode, wherein one side of each of the first electrode and the second electrode is formed to be in alignment with a reference line located at a top portion of the second barrier rib, or wherein one side of each of the first electrode and the second electrode is formed to be located at a predetermined distance from a reference line located at a top portion of the second barrier rib, wherein the distance between the first electrode and the second electrode ranges from 100 μm to 200 μm.

Implementations may include one or more of the following features. For example, a first black layer may be formed on a portion of the front substrate corresponding to the top portion of the second barrier rib. The first black layer may be formed to be at a predetermined distance from the first electrode and the second electrode.

The first electrode and the second electrode each may comprise a transparent electrode and a bus electrode. A second black layer may be formed between the transparent electrode and the bus electrode.

A width of a portion of the first electrode and the second electrode that intersect with the first barrier rib may be less than a width of a portion of the first electrode and the second electrode located within the discharge cell.

In another aspect, there is provided a plasma display panel comprising a first electrode and a second electrode formed in parallel to each other on a front substrate, a third electrode formed on a rear substrate to intersect with the first electrode and the second electrode, a first barrier rib for partitioning a discharge cell, each discharge cell having a different phosphor, between the front substrate and the rear substrate, and a second barrier rib for partitioning a discharge cell, each discharge cell having a same phosphor, between the front substrate and the rear substrate, wherein the second barrier rib is formed in parallel to the first electrode and the second electrode, wherein one side of each of the first electrode and the second electrode are formed to be in alignment with a reference line located at a top portion of the second barrier rib, or wherein one side of each of the first electrode and the second electrode are formed to be located at a predetermined distance from a reference line located at a top portion of the second barrier rib, wherein a width of an top portion of the second barrier rib is equal to or less than a width of an top portion of the first barrier rib.

Implementations may include one or more of the following features. For example, the first electrode and the second electrode each may consist of a bus electrode.

In still another aspect, there is provided a plasma display panel comprising a first electrode and a second electrode formed in parallel to each other on a front substrate, a third electrode formed on a rear substrate to intersect with the first electrode and the second electrode; and a first barrier rib and a second barrier rib which intersect each other for forming a discharge cell between the front substrate and the rear substrate, wherein the second barrier rib is formed in parallel to the first electrode and the second electrode, wherein the distance between one side of each of the first electrode and the second electrode is less than or equal to the distance between the top portion of two adjacent second barrier ribs, and wherein the distance between the first electrode and the second electrode ranges from 100 μm to 200 μm.

Implementations may include one or more of the following features. For example, the distance between the side of each of the first electrode and the second electrode located closest to a second barrier rib may be less than or equal to the distance between the top portion of two adjacent second barrier ribs.

It is to be understood that both the foregoing general description and the following detailed description are exemplary and explanatory and are intended to provide further explanation of the invention as claimed.

### BRIEF DESCRIPTION OF THE DRAWINGS

The invention will be described in detail with reference to the following drawings in which like numerals refer to like elements.

FIG. 1 illustrates the structure of a plasma display panel according to a first embodiment of the present invention;

FIGS. 2a and 2b illustrate the structures of a first electrode and a second electrode of the plasma display panel according to the first embodiment of the present invention;

FIG. 3 illustrates the disposition structure of a black layer in the plasma display panel according to the first embodiment of the present invention;

FIG. 4 illustrates a formation location of a first black layer in the plasma display panel according to the first embodiment of the present invention;

FIGS. 5a and 5b illustrate another disposition structure of the black layer in the plasma display panel according to the first embodiment of the present invention;

FIG. 6 illustrates the structure of a plasma display panel according to a second embodiment of the present invention;

FIG. 7 illustrates the structure of the electrode of the plasma display panel according to the first and second embodiments of the present invention; and

FIG. 8 illustrates a method of driving of the plasma display panel according to the first and second embodiments of the present invention.

### DETAILED DESCRIPTION OF PREFERRED EMBODIMENTS

Preferred embodiments of the present invention will be described in a more detailed manner with reference to the drawings.

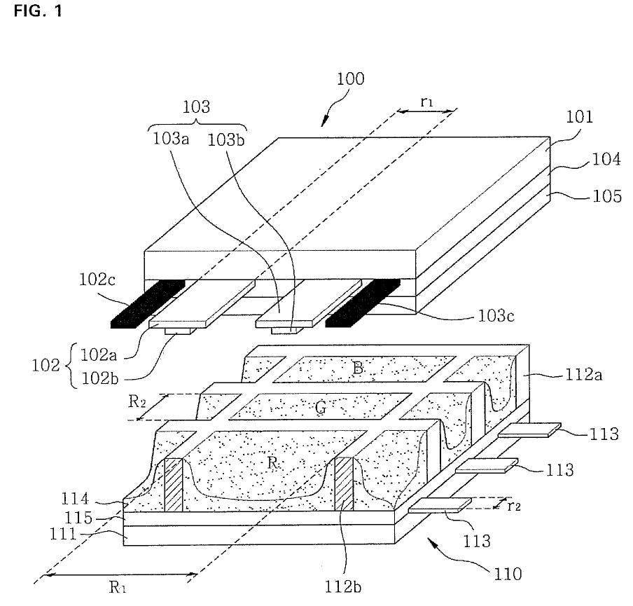

FIG. 1 illustrates the structure of a plasma display panel according to a first embodiment of the present invention.

Referring to FIG. 1, a plasma display panel according to a first embodiment of the present invention comprises a front panel 100 and a rear panel 110 which are coalesced in parallel to each other at a given distance therebetween. The front panel 100 comprises a front substrate 101 on which a first electrode 102 and a second electrode 103 are formed. The rear panel 110 comprises a rear substrate 111 on which a three electrode 113 is formed to intersect with the first electrode 102 and the second electrode 103.

The first electrode 102 and the second electrode 103 are formed in parallel to each other on the front substrate 101. The first electrode 102 and the second electrode 103 generate a discharge within a discharge cell and maintain the discharge of the discharge cell.

Light transmissivity and electrical conductivity of the first electrode 102 and the second electrode 103 need to be considered to emit light generated within the discharge cell to the outside and to secure driving efficiency. Accordingly, it is preferable that the first electrode 102 and the second electrode 103 each comprise transparent electrodes 102a and 103a made of transparent indium-tin-oxide (ITO) material and bus electrodes 102b and 103b made of opaque Ag.

Since the first electrode 102 and the second electrode 103 each comprise the transparent electrodes 102a and 103a, visible light generated in the discharge cell is efficiently emitted to the outside of the plasma display panel.

Since the first electrode 102 and the second electrode 103 each comprise the bus electrodes 102b and 103b, the bus electrodes 102b and 103b prevent a reduction in the driving efficiency caused by the transparent electrodes 102a and 103a with low electrical conductivity. In other words, the bus electrodes 102b and 103b compensate the low electrical conductivity of the transparent electrodes 102a and 103a.

The first electrode 102 and the second electrode 103 each may consist of the bus electrodes 102b and 103b. In other words, the first electrode 102 and the second electrode 103 each may be formed in the form of a single layer, in which the transparent electrodes 102a and 103a are omitted.

When the first electrode 102 and the second electrode 103 each consist of the bus electrodes 102b and 103b, the manufacturing cost of the plasma panel decreases. A distance between the first electrode 102 and the second electrode 103 may be adjusted in consideration of a firing voltage between the first electrode 102 and the second electrode 103 or a firing voltage between the first electrode 102 and the third electrode 113 when driving the plasma panel.

Linewidths r1 of the first electrode 102 and the second electrode 103 may be different from each other to improve a jitter characteristic during the generation of an address discharge between the first electrode 102 or the second electrode 103 and the third electrode 113. However, in the first embodiment of the present invention, the linewidths r1 of the first electrode 102 and the second electrode 103 equal to each other to easily manufacture electrodes.

The linewidth r1 of each of the first electrode 102 and the second electrode 103 ranges from 180 μm to 210 μm. The linewidth r1 of each of the first electrode 102 and the second electrode 103 may increase in proportional to a pitch R1 of the discharge cell.

First black layers 102c and 103c may be formed on the front substrate 111 in parallel to the first electrode 102 and the second electrode 103. The first black layers 102c and 103c prevent reflection of external light. The first electrode 102, the second electrode 103 and the first black layers 102c and 103c will be described in detail below.

An upper dielectric layer 104 may be formed on the front substrate 101, on which the first electrode 102, the second electrode 103 and the first black layers 102c and 103c are formed, to cover the first electrode 102 and the second electrode 103.

The upper dielectric layer 104 limits a discharge current of the first electrode 102 and the second electrode 103 and to provide insulation between the first electrode 102 and the second electrode 103.

A protective layer 105 may be formed on an upper surface of the upper dielectric layer 104 to facilitate discharge conditions. The protective layer 105 may be made of a material with high secondary electron emission coefficient, for example, MgO. The protective layer 105 may be formed using a deposition method.

The upper dielectric layer 104 and a lower dielectric layer 115 each are formed in the form of a single layer in the plasma display panel of FIG. 1. However, at least one of the upper dielectric layer 104 and the lower dielectric layer 115 may comprise a plurality of layers.

The third electrode 113 formed on the rear substrate 111 supplies a data signal to the discharge cell. The third electrode 113 has an equal linewidth r2 throughout the rear substrate 111 to easily manufacture the electrode.

In such a case, the linewidth r2 of the third electrode 113 may range from 60 μm to 80 μm. The linewidth r2 of the third electrode 113 may increase in proportional to a pitch R2 of the discharge cell.

Although it is not shown in the drawings, the third electrode 113 may have a different linewidth r2 throughout the rear substrate 111 to improve the jitter characteristic during the generation of the address discharge between the first electrode 102 or the second electrode 103 and the third electrode 113. In other words, the third electrode 113 may have the widest linewidth at a location corresponding to the first electrode 102 or the second electrode 103.

The lower dielectric layer 115 may be formed on the rear substrate 111 to cover the third electrode 113.

A first barrier rib 112a and a second barrier rib 112b are formed on the lower dielectric layer 115 to partition a discharge space (i.e., discharge cell). The first barrier rib 112a is formed in parallel to the third electrode 113. The second barrier rib 112b is formed to intersect with the third electrode 113.

The discharge cell formed by the first barrier rib 112a and the second barrier rib 112b may have various structures such as a well type, a delta type, a honeycomb type.

The discharge cell formed by the first barrier rib 112a and the second barrier rib 112 is filled with a predetermined discharge gas.

It is preferable that a Xe content in the discharge cell ranges from 10% to 20% of the total discharge gas in the discharge cell. When the Xe content is within the above range, an emission amount of ultraviolet rays increases in proportional to a firing voltage such that conversion efficiency from ultraviolet rays to visible rays increases.

A phosphor 114 for emitting visible rays for an image display when the address discharge occurs is formed within the discharge cell. For example, a red (R) phosphor, a green (G) phosphor and a blue (B) phosphor may be formed.

As described above, the plasma display panel according to the first embodiment of the present invention displays an image by supplying a driving signal to the first electrode 102, the second electrode 103 and the third electrode 113, and then generating a discharge within the discharge cell partitioned by the first barrier rib 112a and the second barrier rib 112b.

The explanation was given of an example of the plasma display panel according to the first embodiment of the present invention in FIG. 1. Thus, the plasma display panel according to the first embodiment of the present invention is not limited to the structure of the plasma display panel illustrated in FIG. 1. For example, a black layer (not shown) for absorbing external light may be formed on the second barrier rib 112b to prevent reflection of external light caused by the first barrier 112a or the second barrier rib 112b.

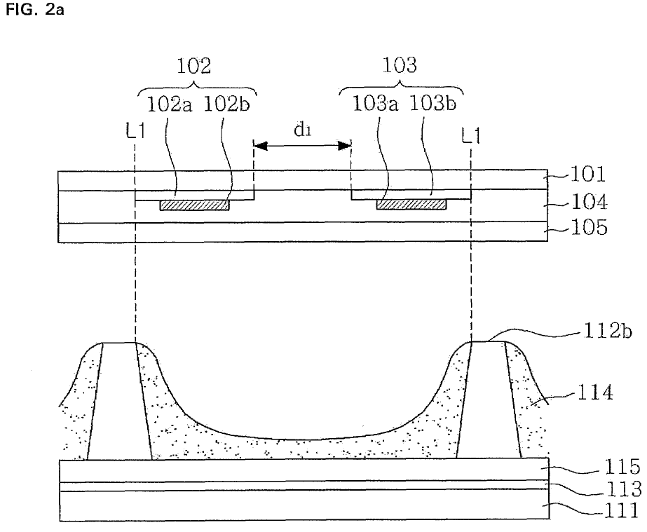

FIGS. 2a and 2b illustrate the structures of a first electrode and a second electrode of the plasma display panel according to the first embodiment of the present invention.

As illustrated in FIG. 2a, each of the first electrode 102 and the second electrode 103 formed on the front substrate 101 may be formed to be in alignment with a reference line L1 located at a top portion of the second barrier rib 112b. Further, as illustrated in FIG. 2b, each of the first electrode 102 and the second electrode 103 may be formed to be located at a predetermined distance from the reference line L1.

A distance between one side of the first electrode 102 and one side of the second electrode 103 may be equal to or less than a distance between top portions of two second barrier ribs 112b corresponding to each of the first electrode 102 and the second electrode 103.

In such a case, one side of the first electrode 102 and one side of the second electrode 103 refer to the side closest to the reference line L1.

This prevents an influence of the discharge on adjacent discharge cell when a discharge occurs in a discharge cell in which the first electrode 102 and the second electrode 103 are arranged.

In such a case, a distance d1 between the first electrode 102 and the second electrode 103 may change according to the size of the discharge cell of the plasma display panel. The distance d1 between the first electrode 102 and the second electrode 103 ranges from about 100 μm to about 200 μm. Preferably, the distance d1 between the first electrode 102 and the second electrode 103 ranges from about 100 μm to about 150 μm.

This secures a sufficient moving distance between ions and electrons generated when a discharge occurs within the discharge cell due to the voltage difference between the first electrode 102 and the second electrode 103, thereby increasing the efficiency of light emission.

The formation location of the first electrode 102 and the second electrode 103 was described based on the reference line L1 located at the top portion of the second barrier 112b in FIGS. 2a and 2b. However, the first electrode 102 and the second electrode 103 may be disposed based on a reference line (not shown) located at a base portion of the second barrier 112b. Since the formation location of the first electrode 102 and the second electrode 103 based on the reference line located at the base portion of the second barrier 112b is the same as the formation location of the first electrode 102 and the second electrode 103 illustrated in FIGS. 2a and 2b, a description thereof is omitted.

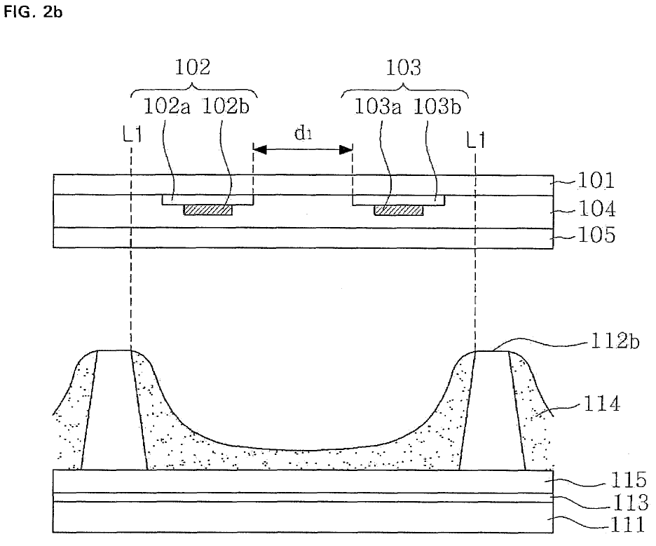

FIG. 3 illustrates the disposition structure of a black layer in the plasma display panel according to the first embodiment of the present invention.

Referring to FIG. 3, the first black layers 102c and 103c are formed on a portion of the front substrate 101 corresponding to the second barrier rib 112b.

In such a case, the first black layer 102c is separated from the first electrode 102 by a predetermined distance d2, and the second black layer 103c is separated from the second electrode 103 by a predetermined distance d2.

This increases an aperture ratio of visible light generated when a discharge occurs, thereby improving a brightness characteristic.

A width w1 of the first black layers 102c and 103c equals to 9/10 of a width w2 of the top portion of the second barrier rib 112b such that the first black layers 102c and 103c are separated from the first electrode 102 and the second electrode 103 by the predetermined distance d2, respectively. The width w1 of the first black layers 102c and 103c may change in accordance with the width w2 of the top portion of the second barrier rib 112b. However, preferably, the width w1 of the first black layers 102c and 103c ranges from 70 μm to 90 μm.

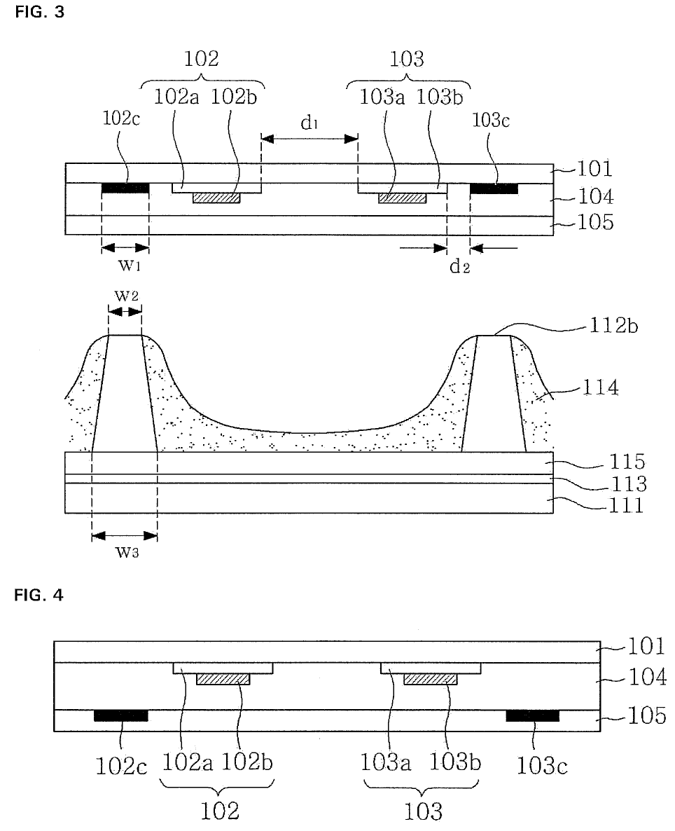

FIG. 4 illustrates a formation location of a first black layer in the plasma display panel according to the first embodiment of the present invention.

Referring to FIG. 4, the first black layers 102c and 103c are formed not on the front substrate 101 but between the upper dielectric layer 103 and the protective layer 105.

Although it is not shown in the drawings, when the front panel comprises a plurality of dielectric layers, the first black layers 102c and 103c may be formed between the plurality of dielectric layers. For example, a dielectric material is coated on the front substrate in a paste state to cover the first electrode and the second electrode, thereby forming a first dielectric layer. Then, a green sheet including the dielectric material is laminated on the front substrate to form a second dielectric layer. The first black layer is formed between the first dielectric layer and second dielectric layer.

In such a case, it is preferable that the first black layer, as illustrated in FIG. 3, is formed at a location corresponding to the second barrier rib.

The front panel of the plasma display panel according to the first embodiment of the present invention may further comprise a second black layer other than the first black layer.

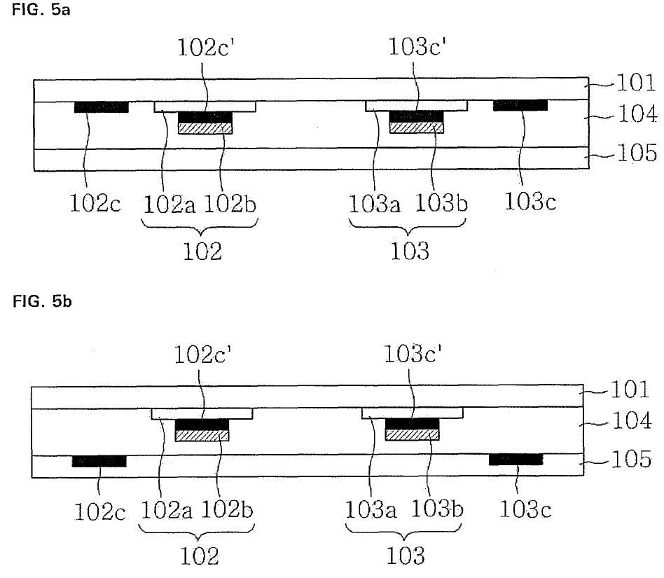

FIGS. 5a and 5b illustrate another disposition structure of the black layer in the plasma display panel according to the first embodiment of the present invention.

Referring to FIG. 5a, when the first electrode 102 and the second electrode 103 each comprise the transparent electrodes 102a and 103a and the bus electrodes 102b and 103b, second black layers 102c′ and 103c′ are formed between the transparent electrodes 102a and 103a and the bus electrodes 102b and 103b, respectively.

In FIG. 5a, the first black layers 102c and 103c are formed on the front substrate 101, on which the transparent electrodes 102a and 103a are formed, in the same way as FIG. 3. The bus electrodes 102b and 103b may be formed on any portions of the transparent electrodes 102a and 103a within the range of the linewidth of the transparent electrodes 102a and 103a. Preferably, the bus electrodes 102b and 103b are formed in the middle of the linewidth of each of the transparent electrodes 102a and 103a.

Further, it is preferable that the linewidth of the second black layers 102c′ and 103c′ is substantially equal to the linewidth of the bus electrodes 102b and 103b. This prevents the reflection of external light caused by the bus electrodes 102b and 103b.

Referring to FIG. 5b, in the same way as FIG. 5a, when the first electrode 102 and the second electrode 103 each comprise the transparent electrodes 102a and 103a and the bus electrodes 102b and 103b, the second black layers 102c′ and 103c′ are formed between the transparent electrodes 102a and 103a and the bus electrodes 102b and 103b, respectively. In FIG. 5b, the first black layer 102c and 103c are formed between the upper dielectric layer 104 and the protective layer 105, in the same way as FIG. 4.

The plasma display panel according to the first embodiment of the present invention reduces a total capacitance as compared with a total capacitance in the related art plasma display panel.

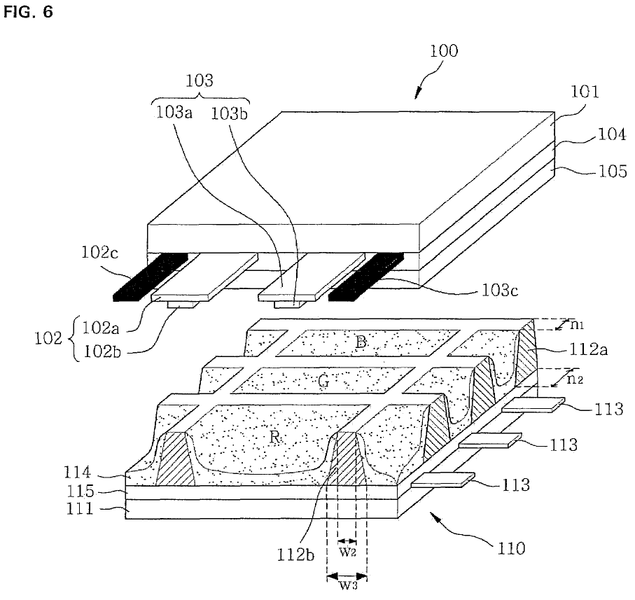

FIG. 6 illustrates the structure of a plasma display panel according to a second embodiment of the present invention.

Referring to FIG. 6, the structure of a plasma display panel according to a second embodiment of the present invention is approximately the same as the structure of the plasma display panel according to the first embodiment of the present invention. Thus, the structure and components identical or equivalent to those described in the first embodiment are designated with the same reference numerals, and the description thereabout is omitted.

A first barrier rib 112a formed between a front substrate 101 and a rear substrate 111 partitions discharge cells including different kinds of phosphors. On the other hand, a second barrier rib 112b formed between the front substrate 101 and the rear substrate 111 partitions discharge cells including the same kind of phosphor.

In such a case, a width n1 of a top portion of the first barrier rib 112a may be equal to or may be different from a width w2 of a top portion of the second barrier rib 112a.

In general, when driving the plasma display panel, priming particles existing within a discharge cell move to an adjacent discharge cell, thereby causing an erroneous discharge. The erroneous discharge is caused by cross talk of the priming particle.

A magnitude of the erroneous discharge caused by cross talk in the discharge cells including the same kind of phosphor is relatively less than a magnitude of the erroneous discharge caused by cross talk in the discharge cells including the different kinds of phosphors. The erroneous discharge caused by cross talk in the discharge cells including the same kind of phosphor slightly affects the definition of the plasma display panel. The erroneous discharge caused by cross talk in the discharge cells including the different kinds of phosphors adversely affects the definition of the plasma display panel.

Accordingly, it is preferable that the width n1 of the top portion of the first barrier rib 112a for partitioning the discharge cells including the different kinds of phosphors is more than the width w2 of the top portion of the second barrier rib 112b for partitioning the discharge cells including the same kind of phosphors.

The width n1 of the top portion and a width n2 of a base portion of the first barrier rib 112a may equal to the width w2 of the top portion and a width w3 of a base portion of the second barrier rib 112b, and thus the barrier rib can be easily manufactured.

The width w3 of the base portion of the second barrier rib 112b ranges from 1.2 to 2.0 times the width w2 of the top portion of the second barrier rib 112b.

When the width w3 of the base portion of the second barrier rib 112b is more than the width w2 of the top portion of the second barrier rib 112b, the barrier rib has the stable structure.

Further, alignment tolerance between the second barrier rib 112b and first black layers 102c and 103c decreases in a manufacturing process of the plasma display panel.

Although it is not shown in the drawings, the locations of the first electrode and the second electrode, the distance between the first electrode and the second electrode, the disposition structure of the first black layer and the second black layer in the plasma display panel according to the second embodiment of the present invention may be same as those in the plasma display panel according to the first embodiment of the present invention.

Accordingly, total capacitance of the plasma display panel according to the second embodiment of the present invention is less than total capacitance of the related art plasma display panel, thereby reducing a reactive power when driving the plasma display panel.

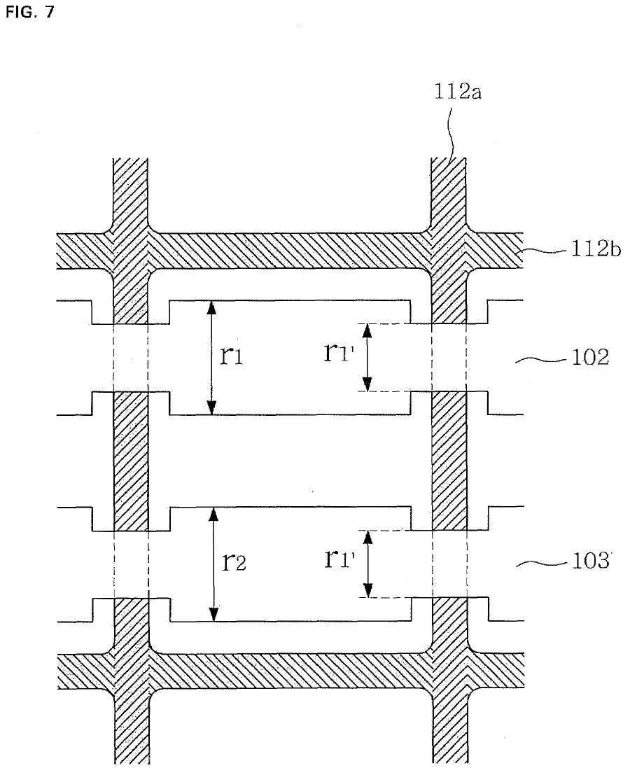

FIG. 7 illustrates the structure of the electrode of the plasma display panel according to the first and second embodiments of the present invention.

As illustrated in FIG. 7, in the plasma display panel according to the first and second embodiments of the present invention, the first electrode 102 and the second electrode 103 formed on the front substrate in parallel to the second barrier rib 112b do not have an equal linewidth throughout the front substrate. In other words, a portion of the first electrode 102 and a portion of the second electrode 103 have a different linewidth from the remaining portion of the first electrode 102 and a different linewidth from the remaining portion of the second electrode 103, respectively.

In general, the barrier rib is made of a dielectric material such that the barrier rib generates dielectric polarization when driving the plasma display panel. Most of charges are accumulated around the barrier rib due to the dielectric polarization of the barrier rib, thereby adversely affecting a firing voltage between the electrodes in a practical discharge region.

Accordingly, in the structure of the electrode of the plasma display panel according to the first and second embodiments of the present invention, linewidths r1′ of portions of the first electrode 102 and the second electrode 103 at a location corresponding to the first barrier rib 112a are less than linewidths r1 of the remaining portions of the first electrode 102 and the second electrode 103.

The above-described structure of the first electrode 102 and the second electrode 103 prevents most of charges from being accumulated on the first barrier rib 112a, thereby causing the stable discharge of the plasma display panel.

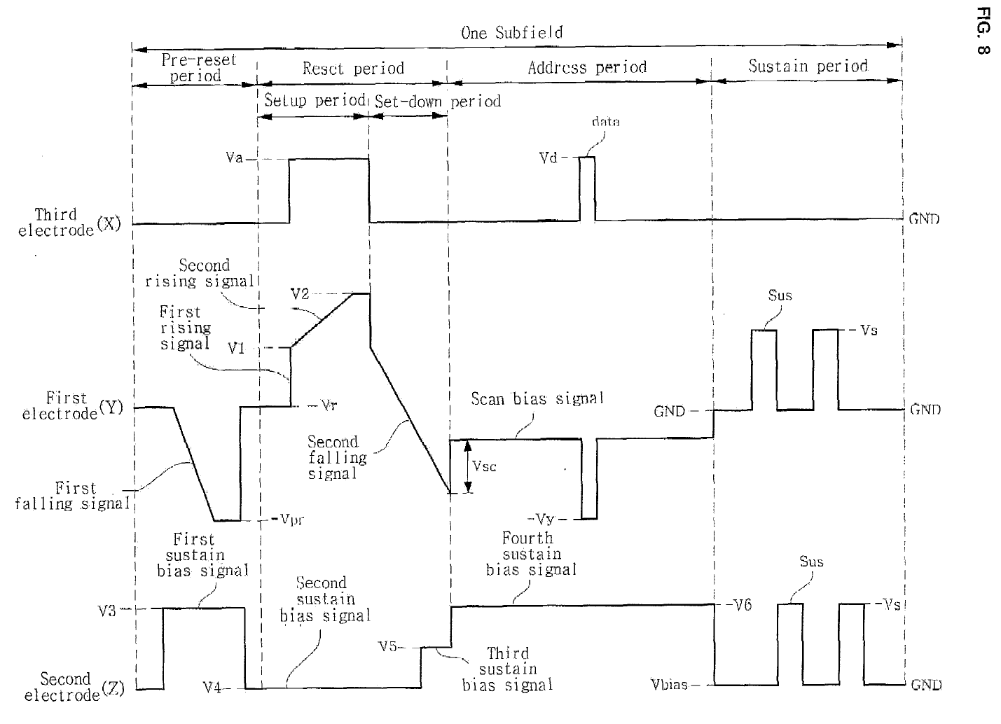

FIG. 8 illustrates a method of driving of the plasma display panel according to the first and second embodiments of the present invention.

Although it is not shown in the drawings, a frame comprises a plurality of subfields and each of the subfields comprises a reset period, an address period and a sustain period. In such a case, as illustrated in FIG. 8, the subfield further comprises a pre-reset period prior to the reset period such that a maximum voltage of a second rising signal supplied during the reset period lowers.

More specifically, a first falling signal is supplied to a first electrode Y during the pre-reset period. A first sustain bias signal of a polarity direction opposite a polarity direction of the first falling signal is supplied to a second electrode Z during the supply of the first falling signal to the first electrode Y.

It is preferable that the first falling signal gradually falls to a voltage −Vpr. Further, the first falling signal may gradually fall from a ground level voltage GND.

It is preferable that first sustain bias signal is substantially maintained at a sustain bias voltage V3. The sustain bias voltage V3 may be substantially equal to a sustain voltage Vs of a sustain signal SUS to be supplied during the sustain period.

During the pre-reset period, the first falling signal is supplied to the first electrode Y, and the first sustain bias signal is supplied to the second electrode Z. This results in wall charges of a predetermined polarity being accumulated on the first electrode Y, and wall charges of a polarity opposite the predetermined polarity being accumulated on the second electrode Z.

Accordingly, a setup discharge with sufficient intensity can occur during the reset period such that initialization of the discharge cells is stably performed.

Although the amount of wall charges within the discharge cell is insufficient, a setup discharge with sufficient intensity can occur during the reset period

All subfields of the frame may comprise the above-described pre-reset period prior to the reset period.

A subfield with lowest-level weight in the subfields of the frame may comprise the pre-reset period before the reset period in consideration of sufficient driving time. Further, two or three subfields in the subfields of the frame may comprise the pre-reset period prior to the reset period in consideration of sufficient driving time.

Further, the above-described pre-reset period may be omitted in all subfields of the frame.

The reset period subsequent to the pre-reset period comprises a setup period and a set-down period. During the setup period, a rising signal of a polarity direction opposite the polarity direction of the first falling signal is supplied to the first electrode Y.

It is preferable that the rising signal comprises a first rising signal which abruptly rises to a voltage of about V1 and a second rising signal which gradually rises from the voltage of about V1 to a voltage of about V2. More preferably, the voltage V1 equals to a voltage Vsc, and the voltage V2 equals to a voltage Vsc+Vs.

It is preferable that a driver (not shown) supplies a second sustain bias signal having a voltage lower than the sustain bias voltage V3 of the first sustain bias signal to the second electrode Z.

It is preferable that the second sustain bias signal is substantially maintained at a second sustain bias voltage V4. The second sustain bias voltage V4 of the second sustain bias signal may equal to the ground level voltage GND.

During the setup period, the rising signal generates a weak dark discharge (i.e., a setup discharge) within the discharge cell. Wall charges are accumulated within the discharge cell by the setup discharge.

It is preferable that a slope of the second rising signal is less than a slope of the first rising signal. In such a case, a voltage of the rising signal supplied to the first electrode rapidly rises before generating the setup discharge, and a voltage of the rising signal slowly rises during the generation of the setup discharge, thereby reducing quantity of light generated by the setup discharge. Accordingly, contrast increases.

The driver supplies a signal of a positive polarity direction, which rises to a voltage Va, to the third electrode X during the setup period.

During the set-down period, the driver supplies a second falling signal subsequent to the supply of the rising signal to the first electrode Y. A polarity direction of the second falling signal is opposite to a polarity direction of the rising signal.

It is preferable that the second falling signal gradually falls from the voltage V2. Further, it is preferable that a voltage magnitude of a scan bias signal equals to a voltage Vsc.

The driver supplies a third sustain bias signal to the second electrode Z during a some period of the supply of the second falling signal to the first electrode Y. The third sustain bias signal is maintained at a sustain bias voltage V5. The sustain bias voltage V5 of the third sustain bias signal is substantially equal to one half of the sustain voltage Vs.

This prevents an erroneous discharge cause by the voltage difference between the first electrode Y and the second electrode Z.

Accordingly, a weak erase discharge (i.e., a set-down discharge) occurs within the discharge cells. Furthermore, by performing the set-down discharge, the remaining wall charges are uniform inside the discharge cells to the extent that the address discharge can be stably performed.

During the address period, a scan bias signal of a negative scan voltage −Vy is sequentially supplied to the first electrode Y and, at the same time, a positive data voltage synchronized with the scan bias signal is supplied to the third electrodes X.

It is preferable that a magnitude of the voltage −Vpr of the first falling signal is three times a magnitude of the negative scan voltage of the scan bias signal. In other words, a relationship of Vy<Vpr≦3Vy is satisfied.

As the voltage difference between the negative scan voltage of the scan bias signal and the data voltage is added to the wall voltage produced during the reset period, the address discharge is generated within the discharge cells to which the data voltage is supplied. The wall charges are formed inside the cells selected by performing the address discharge such that when a sustain voltage Vs of the sustain signal SUS is supplied a sustain discharge occurs. A sustain bias voltage V6 of a fourth sustain bias signal is supplied to the second electrode Z during the set-down period and the address period so that an erroneous discharge does not occur between the sustain electrode Z and the scan electrode Y by reducing the voltage difference between the first electrode Y and the second electrode Z. It is preferable that the sustain voltage of the fourth sustain bias signal is substantially equal to the sustain voltage Vs.

During the sustain period, the sustain signal SUS of the sustain voltage Vs is alternately supplied to the first electrode Y and the second electrode Z. As the wall voltage within the cells selected by performing the address discharge is added to the sustain voltage Vs of the sustain signal SUS, a sustain discharge (i.e., a display discharge) occurs between the scan electrode Y and the sustain electrode Z whenever the sustain signal SUS is supplied.

The driving method of the plasma display panel is limited to the method illustrated in FIG. 8, and may change in accordance with the property of the plasma display panel. The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display panel comprising:
a first electrode and a second electrode formed in parallel to each other on a front substrate;
a third electrode formed on a rear substrate to intersect with the first electrode and the second electrode; and
a first barrier rib and a second barrier rib which intersect each other for forming a discharge cell between the front substrate and the rear substrate,
wherein the second barrier rib is formed in parallel to the first electrode and the second electrode,
wherein one side of each of the first electrode and the second electrode is formed to be in alignment with a reference line located at a top portion of the second barrier rib or,
wherein one side of each of the first electrode and the second electrode is formed to be located at a predetermined distance from a reference line located at a top portion of the second barrier rib,
wherein the distance between the first electrode and the second electrode ranges from 100 μm to 200 μm.

2. The plasma display panel in claim 1, wherein a first black layer is formed on a portion of the front substrate corresponding to the top portion of the second barrier rib, and
wherein the first black layer is formed to be at a predetermined distance from the first electrode and the second electrode.

3. The plasma display panel in claim 2, wherein the first electrode and the second electrode each comprise a transparent electrode and a bus electrode, and
wherein a second black layer is formed between the transparent electrode and the bus electrode.

4. The plasma display panel in claim 2, wherein a width of the first black layer is less than a width of the top portion of the second barrier rib.

5. The plasma display panel in claim 4, wherein the width of the first black layer ranges from 70 μm to 90 μm.

6. The plasma display panel in claim 1, wherein the first electrode and the second electrode each consist of a bus electrode.

7. The plasma display panel in claim 1, wherein a Xe content in a discharge cell ranges from 10% to 20% of a total discharge gas in the discharge cell.

8. The plasma display panel in claim 1, wherein a width of a portion of the first electrode and the second electrode that intersect with the first barrier rib is less than a width of a portion of the first electrode and the second electrode located within the discharge cell.

9. A plasma display panel comprising:
a first electrode and a second electrode formed in parallel to each other on a front substrate;
a third electrode formed on a rear substrate to intersect with the first electrode and the second electrode;
a first barrier rib for partitioning a discharge cell, each discharge cell having a different phosphor, between the front substrate and the rear substrate; and
a second barrier rib for partitioning a discharge cell, each discharge cell having a same phosphor, between the front substrate and the rear substrate,
wherein the second barrier rib is formed in parallel to the first electrode and the second electrode,
wherein one side of each of the first electrode and the second electrode are formed to be in alignment with a reference line located at a top portion of the second barrier rib or,
wherein one side of each of the first electrode and the second electrode are formed to be located at a predetermined distance from a reference line located at a top portion of the second barrier rib,
wherein a width of an top portion of the second barrier rib is equal to or less than a width of an top portion of the first barrier rib.

10. The plasma display panel in claim 9, wherein a width of a base portion of the second barrier rib ranges from 1.2 to 2.0 times the width of a top portion of the second barrier rib.

11. The plasma display panel in claim 9, wherein a distance between the first electrode and the second electrode ranges from 100 μm to 200 μm.

12. The plasma display panel in claim 9, wherein a first black layer is formed on a portion of the front substrate corresponding to the top portion of the second barrier rib, and
wherein the first black layer is formed to be at a predetermined distance from the first electrode and the second electrode.

13. The plasma display panel in claim 12, wherein the first electrode and the second electrode each comprise a transparent electrode and a bus electrode, and
wherein a second black layer is formed between the transparent electrode and the bus electrode.

14. The plasma display panel in claim 12, wherein a width of the first black layer is less than a width of the top portion of the second barrier rib.

15. The plasma display panel in claim 14, wherein the width of the first black layer ranges from 70 μm to 90 μm.

16. The plasma display panel in claim 9, wherein a width of a portion of the first electrode and the second electrode that intersect with the first barrier rib is less than a width of a portion of the first electrode and the second electrode located within the discharge cell.

17. The plasma display panel in claim 9, wherein the first electrode and the second electrode each consist of a bus electrode.

18. The plasma display panel in claim 9, wherein a Xe content in a discharge cell ranges from 10% to 20% of a total discharge gas in the discharge cell.

19. A plasma display panel comprising:
a first electrode and a second electrode formed in parallel to each other on a front substrate;
a third electrode formed on a rear substrate to intersect with the first electrode and the second electrode; and
a first barrier rib and a second barrier rib which intersect each other for forming a discharge cell between the front substrate and the rear substrate,
wherein the second barrier rib is formed in parallel to the first electrode and the second electrode,
wherein the distance between one side of each of the first electrode and the second electrode is less than or equal to the distance between the top portion of two adjacent second barrier ribs, and
wherein the distance between the first electrode and the second electrode ranges from 100 μm to 200 μm.

20. The plasma display panel in claim 19, wherein the distance between the side of each of the first electrode and the second electrode located closest to a second barrier rib is less than or equal to the distance between the top portion of two adjacent second barrier ribs.
